(19) United States
(12) Patent Application Publication
(10) Pub. No.: US 2026/0114485 A1
(43) Pub. Date: Apr. 30, 2026

(54) METHOD FOR PRODUCING AN ALTERNATIVE CITRUS COMPOSITION AND COMPOSITION THEREOF

(71) Applicant: Jiayou Lin, Brighton, MA (US)

(72) Inventor: Jiayou Lin, Brighton, MA (US)

(21) Appl. No.: 18/927,881

(22) Filed: Oct. 26, 2024

(51) Int. Cl. A23L 27/12; A23L 27/00; A23L 29/10; A23L 29/231

(52) U.S. Cl. CPC A23L 27/13; A23L 27/80; A23L 29/10; A23L 29/231

(57) ABSTRACT

A method of preparing a flavoring composition and composition thereof for imparting citrus juice flavor, taste, and aroma to food stuffs comprising a nano emulsion comprising a mixture of acids, emulsifiers, essential oils, weighting agents, and a thickening and texturizing agent wherein the composition comprises essential oils at 100 to 200 parts per million (ppm); flavor compound mix (selected from a group of recipes) at 50 to 100 ppm, pectin at 0.5 to 1.0% by weight or 5,000 to 10,000 ppm among other ingredients specific to the type of citrus fruit to be imparted.

### FIELD OF DISCLOSURE

The present invention relates generally to a citrus flavored flavoring composition containing a mixture of acids, emulsifiers, essential oils, weighting agents, and a thickening and texturizing agent. This improved flavoring composition imparts a sensory experience of a citrus juice when added to foodstuffs, such as cocktails, beverages, candy, chocolate, or any other type of food or drink item.

### BACKGROUND

Citrus juice is commonly consumed on its own and mixed in other consumables, such as cocktails. Producing fresh citrus juice is labor intensive and the citrus fruit themselves are not cheap. A major component of citrus flavor are terpenes, which are subject to oxidation and break down quickly. Frequent problems of fresh citrus juices after juicing include an unpleasant bitterness may develop, some of their aroma is lost, and there is a decline in quality. Even when frozen, the enzymes that cause bitterness slow down but do not deactivate. Freezing is also likely to lose some volatile aromas to sublimation. Regardless, freshly squeezed citrus juice deteriorates quickly.

Under federal regulatory rules (e.g., 21 CFR § 120), hazard analysis and critical control point (HACCP) systems are required for juices, which is defined as “the aqueous liquid expressed or extracted from one or more fruits or vegetables, purees of the edible portions of one or more fruits or vegetables, or any concentrates of such liquid or puree.” 21 CFR § 120.1(a). With some exceptions, juice is commonly pasteurized as part of a written Hazard Analysis Critical Control Point (HACCP) plan. Pasteurization is a heat treatment process that inhibits the development of microorganisms, a common hazard during the handling of agricultural products. Unfortunately, pasteurization of juices is associated with deterioration of taste and flavor in comparison to their raw form. Freshly squeezed citrus juices contain volatile compounds, including terpenes, such as limonene, linalool, and citronellal, which contribute to flavoring and aromatic qualities. Most terpenes will begin to degrade at around 100° F. When solutions containing terpenes such as juice are pasteurized, they are usually heated at temperatures higher than 100° F., resulting in degradation of terpenes and thus, the flavor of the juice.

An alternative to thermal pasteurization includes high pressure processing (HPP), also known as pascalization. HPP requires specialized machines that are expensive to buy and maintain. The high-cost factors such as energy usage, operational costs, and the limited availability of equipment and skilled operators can make HPP prohibitive to use compared to thermal pasteurization. Pasteurization machine costs range in the thousands of dollars as opposed to the millions for HPP machines.

Furthermore, other solutions for artificial citrus flavoring include acid solutions, but none work well as a substitute for fresh juice. Problems include one-dimensional flavor, lacking texture and viscosity, and having no odor, which are critical to taste. Some solutions may suffice but are not complex or convincing enough to provide the satisfaction of fresh juice.

A further limitation is the availability and cost of citrus fruit. The availability of citrus fruit varies throughout the year, which also affects cost. Climate change and agricultural pests also affect cost and availability. With so much variability and increased costs, dependency on citrus fruits for use in foodstuffs can be limiting.

Accordingly, there exists a need for a shelf stable flavoring composition that provides the complexity, texture, odor, and flavor of citrus juices but is also low cost, limits oxidization, is not dependent on agricultural conditions, and produces only a fraction of kitchen waste compared to freshly squeezed juice.

### SUMMARY

The present description includes one or more non-limiting embodiments for a citrus flavored flavoring composition containing a mixture of acids, emulsifiers, essential oils, weighting agents, and a thickening and texturizing agent. In a non-limiting embodiment, the citrus flavored flavoring composition is prepared by creating an aqueous phase mixture and oil phase mixture that are combined. The aqueous phase comprises 1.0-10.0% of total acids by weight, 0.05-1.5% of total emulsifiers by weight, 0.05-1.5% of total texturizers by weight, and 0.5%-30% of total sugars by weight. The aqueous phase for high acidity citrus fruits comprises (measured in percent by weight): 0.50 to 2.00% sucrose; 1.0 to 8.0% citric acid; 0.0 to 5.0% malic acid; 0 to 0.10% succinic acid; 0% dextrose; 0 to 0.10% vitamin E, 0.05 to 0.50% ascorbic acid; 0.5 to 3.0% fructose; 0.05 to 0.50% sodium; 0.05-0.50% emulsifier; 0.05 to 0.50% texturizer, and a remaining percentage of water, wherein high acidity means a pH of 2 or less for the aqueous phase; and wherein the aqueous phase for medium acidity fruits comprises (measured in percent by weight): 1.0 to 8.0% sucrose; 1.0 to 3.0% citric acid; 0.0 to 3.0% malic acid; 0.0% succinic acid; 1.0 to 5.0% dextrose; 0 to 0.10% vitamin E, 0.05 to 0.50% ascorbic acid; 1.0 to 8.0% fructose; 0.05 to 0.50% sodium; 0.05-0.50% emulsifier; 0.05 to 0.50% texturizer; and a remaining percentage of water, wherein medium acidity means a pH greater than 2 and 3 or less for the aqueous phase. The preferred emulsifier comprises gum acacia. The preferred texturizer comprises pectin. The preferred weighting agent comprises sucrose acetate isobutyrate (SAIB) or ester gum.

The oil phase comprises an essential oil and/or functional oil at 100 to 200 parts per million (ppm), a flavor compound mixture at 50 to 100 ppm, and a weighting agent proportionate to the total amount of the essential oil and/or functional oil and the flavor compound mixture. Citrus peels are prepared and added to the aqueous/oil mixture. The mixture is then processed using a rotor stator and ultrasonic homogenizer until a homogenous, stable nano emulsion is achieved. The nano emulsion is then filtered, taking care to filter with a 20-micron filter within thirty minutes of adding the citrus peels to the mixture. The nano emulsion is adjusted for pH and checked for quality control before packaging. Ideally, all processes and packaging are done in an oxygen-free environment to minimize oxidation. The oxygen-free environment may preferably be created by purging sealed tanks with an inert gas, such as, but not limited to, nitrogen gas (N2) and argon gas (Ar). Alternatively, a vacuum pump pulls a vacuum in the sealed tanks, which has an added benefit of achieving better, more stable emulsions as homogenization under vacuum promotes stability in emulsions.

In some embodiments, the nano emulsion mixture imparts flavors and scents from various citrus fruits, such as, but not limited to, lemons, limes, oranges, grapefruits, yuzu, mandarins, and tangelos. The flavors and scents may resemble a single citrus fruit or a mixture. For example, the aqueous phase, the essential oil or functional oil and lipid-based flavor compound for the oil phase, and the citrus peels may all come from or resemble a single citrus fruit. In another example, the aqueous phase, the essential oil or functional oil and lipid-based flavor compound for the oil phase, and the citrus peels may come from or resemble different citrus fruits such that there may be an aroma of orange with a taste of lemon. In such a combination, the functional oil of avocado oil may be included for its antioxidant and gut health benefits among others. For example, while the aqueous phase may resemble lemons, the essential oil may be pressed from oranges, the lipid-based flavor compound for the oil phase may resemble limes, and the citrus peels may be prepared from mandarins. Furthermore, each of the aqueous phase and oil phase may comprise a sensory quality of a single citrus fruit type or more. For example, the aqueous phase may comprise a mixture where half imparts lemon characteristics, and another half imparts orange characteristics. Different combinations may lead to nano emulsions that smell like lemons but taste like oranges. Combinations with functional oils may provide further benefits beyond smell and taste. These are examples only and do not limit the possible combinations of types of citrus fruits.

Furthermore, the essential oil and/or functional oil added in the oil phase is not limited to only citrus essential oils. The oil phase may comprise botanical and phytogenic compounds (entire or processed parts of a plant), which encompass functional oils and essential oils. Functional oils or essential oils such as rosemary essential oil or extract and argan oil may be added for their antioxidant benefits.

When adjusting the pH of the final nano emulsion mixture, high-acidity alternative citrus juices such as lemon and lime should have a final pH<=2.0 (equal to two or less), medium to low-acidity alternative citrus juices such as orange and grapefruit should have a final pH<=3.0 (equal to three or less). High acidity means any citrus that has more than 3% acid by weight for the aqueous phase mixture. Medium acidity means any citrus that has 3% acid or less by weight for the aqueous phase mixture.

In a non-limiting embodiment, the citrus peels may be omitted or left out to create a nano emulsion mixture without using any actual fruit. Skipping the addition of citrus peels may reduce the cost of creating a nano emulsion mixture, especially when the availability of citrus fruit is limited and therefore more costly. When the citrus peels are omitted, the filtration step may also be skipped as there would be no fruit peel particles to filter out. Furthermore, food coloring may optionally be added when desired in the aqueous phase or oil phase depending on their solubility (i.e., water soluble food coloring to the aqueous phase and oil soluble food coloring to the oil phase). Ideally, all steps of the method are done in an oxygen free environment, via vacuum or inert gas purging, and at zero to 6 degrees Celsius, taking care to avoid freezing as freezing will cause the nano emulsion to deteriorate (i.e., break emulsion).

A proper nano emulsion of a mixture of emulsifiers, stabilizers, and weighting agents allow this alternative citrus juice to combat oxidation. When stored at temperatures between 34° F. to 75° F. the product will retain all of its sensory qualities for at least sixty (60) days.

Other aspects and advantages of the invention will be apparent from the following description and the appended claims.

### BRIEF DESCRIPTION OF THE DRAWINGS

Embodiments of the present disclosure are described in detail below with reference to the following drawing. These and other features, aspects, and advantages of the present disclosure will become better understood with regard to the following description, appended claims, and accompanying drawing. The drawing described herein is for illustrative purposes only of selected embodiments and not all possible implementations and are not intended to limit the scope of the present disclosure.

Other aspects and advantages of the invention will be apparent from the following description and appended claims.

FIG. 1 depicts a block diagram of one or more components of a flavoring composition.

FIG. 2 depicts a flowchart for a non-limiting method for preparing a flavoring composition.

### DETAILED DESCRIPTION

The present description is drawn to a novel flavoring composition that imparts a sensory experience of a citrus juice when added to foodstuffs, such as, but not limited to, cocktails, beverages, candy, chocolate, or any other type of food or drink item.

In accordance with non-limiting embodiments, the flavoring composition comprises a mixture of acids, emulsifiers, essential oils, weighting agents, and a thickening and texturizing agent. The citrus flavored flavoring composition may also be referred to as an alternative citrus composition, alternative citrus juice, artificial juice, flavoring composition, citrus flavoring composition, nano emulsion, nano-emulsion, or final product.

While the present invention is particularly suited for adding to cocktails, addition to other foodstuffs such as snacks, sauces, desserts, and beverages would be useful as well.

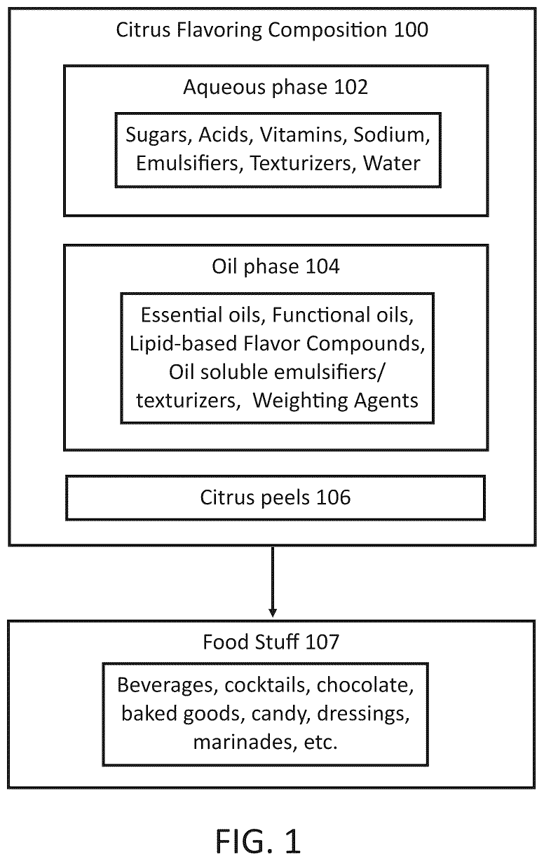

FIG. 1 shows an exemplary block diagram illustrating one or more non-limiting components of a citrus flavoring composition 100. Citrus flavoring composition 100 comprises aqueous phase 102, oil phase 104, and citrus peels 106. Citrus flavoring composition 100 is intended to be added to food stuff 107. Aqueous phase 102 comprises sugars, acids, vitamins, sodium, emulsifier, texturizer, and water. Oil phase 104 comprises essential oils, functional oils, lipid-based flavor compounds, and oil soluble weighting agents. Lipid-based flavor compounds may also be referred to as flavor compounds. Oil soluble weighting agents may be referred to as weighting agents. Although citrus flavoring composition 100 is shown to comprise citrus peels 106, citrus peels 106 is optionally omitted or left out to create a lower cost version of citrus flavoring composition 100. Further details of aqueous phase 102 and oil phase 104 are provided below.

Citrus flavoring composition 100 is not intended to be consumed alone. Rather, citrus flavoring composition 100 is intended to be added to food stuff 107. Food stuff 107 may be anything that is fit for consumption, such as beverages, cocktails, chocolate, baked goods, candy, snacks, sauces, dressings, marinades, etc. The possibilities of food stuff 107 is endless as it can be appreciated that many consumables can benefit from a citrus additive for aroma, flavor, and/or functional benefits.

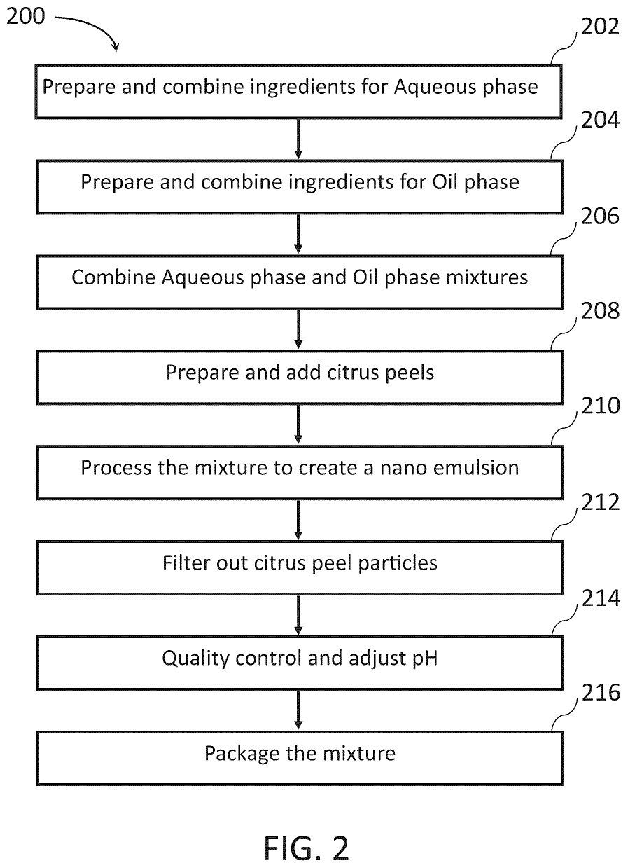

FIG. 2 shows a flowchart depicting a non-limiting embodiment of an exemplary method for preparing a flavoring composition. Method 200 comprises preparing and combining ingredients for an aqueous phase 102 in step 202. The aqueous phase 102 ingredients vary according to the desired citrus fruit type to be incorporated in the flavoring composition. Possible citrus fruit types and ingredient combinations for artificial juice mixes are further discussed below.

Step 204 comprises preparing and combining ingredients for an oil phase 104. Oil phase 104 comprises using cold pressed organic essential oils and/or functional oils at 100 to 200 parts per million (ppm). Cold-pressed essential oils are attained by pressing citrus peels or other essential oil-bearing materials or functional oil-bearing materials, such as juniper berries, with high pressures, which forces the essential oils and/or functional oils to be released and collected. Essential oils may also be acquired by distillation, which is a more efficient method than by cold press, but the high temperatures required for distillation will destroy and degrade many important flavor compounds in essential oils that are vital for their sensory qualities. Citrus essential oils used are preferably extracted by cold press extraction. Other oils, such as functional oils may be extracted by distillation, solvent extraction, CO2 extraction, maceration, enfleurage, cold press extraction, etc.

Although the oil phase 104 ingredients vary according to the desired citrus fruit type to be incorporated in the flavoring composition, a flavor compound mix for the desired citrus fruit type is added at 50 to 100 ppm. The flavor compound mix may also be referred to as lipid-based flavor compound, flavor compound generally or with a specific citrus fruit for the type of flavor, such as lemon flavor compound. The flavor compound mix is included to further emphasize certain aspects of the flavor profile if needed. However, the addition of the flavor compound mix is optional. Possible citrus fruit types and ingredient combinations for the flavor compound mix are further discussed below. Added to the essential oil and/or functional oil and flavor compound mix is a weighting agent proportionate to the total amount of essential oil and/or functional oil and flavor compound in the mixture where the range is 150 to 300 ppm for the weighting agent. The preferred weighting agent is sucrose acetate isobutyrate (SAIB) or ester gum, however, others may be used to serve the same purposes.

While step 202 for preparing the aqueous phase 102 is shown as coming before step 204 for preparing the oil phase 104, these steps can be switched such that the oil phase 104 is prepared before the aqueous phase 102 is prepared. Nonetheless, both aqueous phase 102 and oil phase 104 may be prepared prior to combining them in the next step, i.e., step 206.

In step 206, the aqueous phase 102 and oil phase 104 mixtures are combined, to which citrus peels 106 are added in step 208. The oil phase 104 added to the aqueous phase 102 is a percentage of the latter. The range for the oil phase 104 in the aqueous phase 102 is 150 to 500 ppm.

Step 208 comprises preparing citrus peels 106 and adding to the aqueous/oil mixture if citrus peels 106 are used, which as further discussed below, is optional. The peels 106 of a desired citrus fruit are prepared, carefully avoiding the pith as much as possible to peel only the layer of zest. The pith, the white inner part that is closer to the interior pulp, must be avoided as much as possible to limit unpleasant bitterness in flavor. Ideally, only the zest, the thin outermost layer, is collected to impart the bright citrusy flavor and aroma from the essential oils of the fruit. The amount of zest (or weight of zest) depends on the specific citrus fruit selected in combination with the aqueous phase 102 and oil phase 104. In some embodiments, there is 2 to 20 grams of zest per liter of the final product. The citrus zest 106 in step 208 may be freshly prepared or be frozen citrus zest 106 that was pre-prepared for subsequent use.

Once the zest has been added to the aqueous/oil mixture, it is important to keep track of time such that contact with the zest is limited to thirty minutes or less. This contact time is from the point of adding the zest to the mixture until filtration of the zest particles out of the nano emulsified mixture. Contact time may be more than thirty minutes, however, thirty minutes or less is ideal and preferable in order to minimize the formation of limonin, which is the major bittering agent in citrus juices. Limonin is formed from its tasteless precursor, limonin hydroxyacid lactone, which is located in the tissues of the fruit. Upon contact with acid, limonin hydroxyacid lactone converts to limonin. Minimizing the contact time of citrus zest with the rest of the mixture, which is acidic, can effectively reduce the amount of limonin present in the final product. As discussed further below, step 208 of preparing and adding the citrus peels 106 may be optional.

Step 210 comprises processing the aqueous/oil mixture to create a stable nano emulsion. The mixture is processed using rotor stators and ultrasonic homogenizers until a stable nano emulsion is achieved. Rotor stators generate the necessary mechanical force or shearing action to efficiently mix materials at a microscopic level to produce a homogenous mixture. Ultrasonic homogenizers disrupt particles via sound waves and the cavitation that they cause. The rapidly vibrating homogenizer tip blasts particles with massive amounts of energy which creates bubbles that form and collapse, tearing apart particles in the solution.

A rotor stator may be used first to create a course emulsion to break peels 106 into smaller shreds to make it easier for the ultrasonic homogenizer to create a stable nano emulsion. The rotor stator and the ultrasonic homogenizer may each be done separately or, alternatively, rotor stator and ultrasonic homogenizer methods maybe be performed simultaneously in one container, tank, or machine. Other high energy methods may be used as long as long as the final droplet size is in range. Droplets in the nano emulsion may preferably range in size measuring from 0.5 to 1.0 micrometers (μm) (e.g., 500 to 1,000 nanometers (nm)). Micrometers may also be referred to as microns. In non-limiting embodiments, the nano emulsion preferably has a droplet size distribution in such a way that at least 45 volume %, preferably at least 55 volume %, even more preferably at least 65 volume %, and even more preferably at least 75 volume % has a diameter less than 1 micrometers (m). More preferably, at least 45 volume %, preferably at least 55 volume %, even more preferably at least 65 volume %, and even more preferably at least 75 volume % has a diameter between 0.5 and 1 m. Even more preferably at least 55 volume %, preferably at least 65 volume %, even more preferably at least 75 volume %, and even more preferably at least 85 volume % has a diameter between 0.5 and 1 m. Volume % may also be referred to as percent by volume or % volume. The oil-in-water nano emulsification minimizes oxidation and hydrolysis, which contributes to the flavor, texture, and prolonged shelf life of the mixture.

Step 212 comprises filtering out the citrus peel 106 particles. In non-limiting embodiments, the nano emulsion is filtered through a 20-micron filter to filter out citrus peel 106 particles, which may affect the transparency or opacity of the mixture. If there was no peel 106 added in step 208, filtering is not necessary as there are no peel 106 particles to filter out.

Step 214 comprises quality control and adjustment of pH of the final product. The droplets are checked for their size, ensuring the nano emulsion has droplet sizes within the range of 500-1,000 nm and the percentage by volume preferably at 45 percent by volume at the minimum. High acidity mixtures for citrus fruits such as lemon and lime are adjusted to have a final pH less than or equal to 2.0. Medium acidity mixtures for citrus fruits such as orange and grapefruit are adjusted to have a final pH of less than or equal to 3.0. For the purposes of this step 214 of pH adjustment, high acidity means any citrus that has more than 3% acid by weight for the aqueous phase 102, and medium acidity means any citrus that has 3% or less acid by weight for the aqueous phase 102. The adjustment of pH depends on the citrus fruit resembled in the aqueous phase 102 and is adjusted by adding more acid or dilution. The pH adjustments are done by adding the corresponding acids in the corresponding proportions. For example, as shown in Table 2 below, lime juice for the aqueous base comprises 4% citric acid and 2% malic acid, which has a two-to-one (2:1) ratio of citric acid to malic acid. Thus, when adjusting the pH of a composition comprising lime aqueous phase 102, a 2:1 mixture of citric acid to malic acid is added to lower the pH or add acidity. If the aqueous phase 102 comprises half high acidity mixture and half medium acidity mixture (such as half lemon and half orange), the pH should be adjusted to the average of the two halves.

Step 216 comprises packaging the nano emulsified mixture or final product, which may be colored. Food coloring may optionally be added when desired to the aqueous phase 102 or oil phase 104 depending on the solubility of the food coloring. Water soluble food coloring may be added to the aqueous phase 102 and oil soluble food coloring may be added to the oil phase 104. Ideally, all steps of the method 200 are done in an oxygen free environment, via vacuum or inert gas purging, and at zero to 6 degrees Celsius, taking care to avoid freezing. It is ideal to avoid freezing as freezing will cause the nano emulsion to deteriorate, i.e., break emulsion.

An oxygen-free environment is achieved by flushing the entire system with inert gases, most commonly nitrogen gas (N2) and argon gas (Ar). The system may comprise reactor tanks, collection tanks, tanks filled with inert gas, pipes, sensors such as pressure and temperature meters, valves, homogenizers, etc. After the dry ingredients of the aqueous phase 102 are measured, each dry ingredient is placed into a jacketed reactor tank. A jacketed reactor tank allows the installation of homogenizers on the reactor tank and the “jacket” allows the entire reactor tank to be chilled, most commonly with glycol-based chillers. After all of the dry ingredients of the aqueous phase 102 have been measured and added to the jacketed reactor tank, cold water, the oil phase 104, and lastly the peels 106 (if used) are added into the jacketed reactor tank. The jacketed reactor tank is then sealed and purged with inert gas to achieve an oxygen-free environment for further processing. After the mixture has been sufficiently processed in the jacketed reactor tank to create a proper nano emulsion, the mixture is optionally filtered using an inline bag or cartridge filter at a particle size of 20 microns into a collection tank. Both the filtration device and the collection tank may be purged with inert gas to further ensure minimal contact with oxygen. While FIG. 2 illustrates the ideal steps to minimize creating bitterness, the aqueous phase 102, the oil phase 104, and peels 106 may all be added in one jacketed reactor tank, sealed, purged with inert gas, and then mixed via processing for creating a nano emulsion.

Alternatively to purging with an inert gas prior to homogenization, an oxygen-free environment may be achieved through pulling a full vacuum in the jacketed reactor tanks with a vacuum pump. The vacuum approach has an added benefit of achieving better, more stable nano emulsions as homogenization under a vacuum promotes stability in emulsions. After the mixture has been sufficiently processed in the jacketed reactor tank to create a proper nano emulsion, inert gases may be pumped into the reactor tank to provide the necessary pressure for the ensuing filtration step 212. The processed nano emulsion mixture may then be filtered by an inert gas purged inline bag or cartridge filter at a particle size of 20 microns into a collection tank. Most reactor and collection tanks can withstand positive pressure for inert gas purges and possibly higher pressure for inter gas pressure driven transfer and filtration of the mixture. However, only specifically “full vacuum” rated tanks can withstand the vacuum necessary for the vacuum method of creating an oxygen-free environment. Pulling a vacuum on a tank that has not been rated as “full vacuum” will cause the tank to implode. Thus, when using the vacuum method, care must be taken to utilize “full vacuum” rated tanks.

Purging of the sealed reactor tank is done by connecting the sealed tank to an inert gas source, most commonly a tank of inert gas, wherein the tank may be filled with the user selected inert gas, such as, but not limited to, nitrogen gas or argon gas. The sealed reactor tank is monitored with a pressure meter and the inert gas source is closed off when the pressure in the sealed reactor tank reaches 7 pounds per square inch (psi). After the inert gas source is closed off, another port on the sealed reactor tank is opened to allow the built-up pressure and gases to evacuate the tank. The filling and evacuation of inert gas is ideally repeated three times, but a repetition of other number of times may be done as long as the goal of limiting oxidation of the mixture is achieved. The final time the sealed reactor tank is filled with inert gas until reaching 7 psi of pressure, the built-up pressure and gases are not allowed to evacuate.

Filtration using an inline bag or cartridge filter requires pressure to perform their filtration functions. Pressure can be achieved through increasing the air pressure in the input size, meaning the reactor tank opening a port on the receiving collection tanks so that there is a pressure difference between the input and output side of the filtration device. Alternatively, pressure can also be achieved using a transfer pump between the reactor tank and the filtration device to create the necessary pressure for filtration.

The following table (Table 1) shows base ingredient combinations in percent by weight (Wt %) for the aqueous phase 102 in step 202:

TABLE 1

| | |
|---|---|
| High Acidity Base | Medium Acidity Base |

| Ingredient | Wt % | Ingredient | Wt % |
|---|---|---|---|
| Sucrose | 0.50-2.00% | Sucrose | 1.00-8.00% |
| Citric Acid | 1.00-8.00% | Citric Acid | 1.00-3.00% |
| Malic Acid | 0.00-5.00% | Malic Acid | 0.00-3.00% |
| Succinic Acid | 0.00-0.10% | Succinic Acid | 0.00% |
| Dextrose | 0.00% | Dextrose | 1.00-5.00% |
| Vitamin E | 0.00-0.10% | Vitamin E | 0.00-0.10% |
| Ascorbic Acid | 0.05-0.50% | Ascorbic Acid | 0.05-0.50% |
| Fructose | 0.50-3.00% | Fructose | 1.00-8.00% |
| Sodium | 0.05-0.50% | Sodium | 0.05-0.50% |
| Emulsifier | 0.05-0.50% | Emulsifier | 0.05-0.50% |
| Texturizer | 0.05-0.50% | Texturizer | 0.05-0.50% |
| Water | Remaining | Water | Remaining |

There are two base ingredients for high acidity citrus and medium acidity citrus. High acidity means any citrus that has more than 3% acid by weight for the aqueous phase mixture. Medium acidity means any citrus that has 3% acid or less by weight for the aqueous phase mixture. For example, high-acidity alternative citrus juices such as lemon and lime should have a final pH of two or less than two (pH<=2.0), and medium to low-acidity alternative citrus juices such as orange and grapefruit should have a final pH of three or lower than three but greater than 2.0 (2.0<pH<=3.0). The main differences between the ingredients for the high and medium acidity bases are the ranges for each ingredient, which vary according to the citrus type that is desired.

The “Remaining” for water in Table 1 means to add an amount of water to bring the total amount to 100 percent. For example, for simplicity, if the maximum amount for each ingredient for the high acidity base was used to create the aqueous phase 102, the following amounts of ingredients would be used: 2% sucrose, 8% citric acid, 5% malic acid, 0.1% succinic acid, 0% dextrose, 0.1% vitamin E, 0.5% ascorbic acid, 3% fructose, 0.5% sodium, 0.5% emulsifier, 0.5% texturizer, and 79.8% water. The percent by weight for water is calculated by adding the percent by weight for each ingredient and then subtracting that total percent by weight from 100 percent, which is the “remaining” percent by weight.

In addition to the ranges of ingredients shown in Table 1 above, the aqueous phase 102 is also limited to an overall range of 1.0-10.0% of total acids by weight, 0.05-1.5% of total emulsifiers by weight, 0.05-1.5% of total texturizers by weight, and 0.5%-30% of total sugars by weight. For example, lime aqueous base, shown in Table 2 below, has 4% citric and 2% malic acid, making it 6% in total acids by weight. Lime aqueous base also has 0.5% sucrose and 1.0% fructose, making it 1.5% of total sugars by weight, along with 0.1% of emulsifier and 0.1% of texturizer by weight. The ranges for each type or category of ingredients for lime aqueous base fits within the above parameters. However, the above example of a high acidity aqueous base having a value at the maximum of each range shown in Table 1 would not fit within the above parameters because 8% citric acid and 5% malic acid would total 14% in acids, which is outside of the parameter range of 1.0-10.0% of total acids by weight.

The following table (Table 2) shows examples of aqueous phase 102 ingredients for specific citrus fruits created based on the high and medium bases shown in Table 1.

TABLE 2

| | Lemon Aqueous Base | Lime Aqueous Base | Orange Aqueous Base |
|---|---|---|---|
| | (High Acidity) | (High Acidity) | (Medium Acidity) |
| Ingredient | Wt % | Wt % | Wt % |
| Sucrose | 0.50% | 0.50% | 4.00% |
| Citric Acid | 6.00% | 4.00% | 1.00% |
| Malic Acid | 0% | 2.00% | 0.20% |
| Succinic Acid | 0% | 0.02% | 0% |
| Dextrose | 0% | 0% | 2.00% |
| Vitamin E | 0.05% | 0.05% | 0.05% |
| Ascorbic Acid | 0.10% | 0.10% | 0.10% |
| Fructose | 1.30% | 1.00% | 2.00% |
| Sodium | 0.10% | 0.10% | 0.20% |
| Emulsifier (Acacia gum) | 0.10% | 0.10% | 0.15% |
| Texturizer (pectin) | 0.10% | 0.10% | 0.20% |
| Water | Remaining | Remaining | Remaining |

The amounts of ingredients are shown for lemon, lime, and orange citrus fruits. As can be seen in Table 2, amounts vary between citrus fruit type. However, this is not limiting and ingredient amounts for other types of citrus fruit may also be used, such as yuzu and grapefruit. Additionally, the citrus fruit type may be a single citrus fruit type or a mix of more than one citrus fruit type. For example, lemon aqueous base and lime aqueous base may be mixed for a mixture of high acidity flavors. Furthermore, citrus fruit types in the high acidity base and the medium acidity base may be mixed as well. For example, a mixture of lemon aqueous base and orange aqueous base may be mixed to culminate in an aqueous base with the acidity of lemons and the sugar composition of oranges. The example citrus fruit type mixtures are non-limiting and may include other types of citrus fruits as well. The preferred emulsifier is acacia gum but any other emulsifier, such as polysorbate, that achieves the same purpose may be used. Acacia gum may also be referred to as gum acacia, gum Arabic, and acacia Senegal. Similarly, the preferred texturizer is pectin but any other texturizer that achieves the same purpose may be used.

The following table (Table 3) shows ingredient combinations for flavor compound mixes for the oil phase 104 in step 204.

TABLE 3

| Lemon Flavor Compound | | Lime Flavor Compound | | Orange Flavor Compound | |
|---|---|---|---|---|---|
| Ingredient | Wt % | Ingredient | Wt % | Ingredient | Wt % |
| Alpha Pinene | 1% | Linalool | 2% | Beta Pinene | 0.05% |
| Linalool | 1% | Sabinene | 2% | Sabinene | 0.1% |
| Sabinene | 2% | Myrcene | 3% | Citral | 0.2% |
| Myrcene | 2% | Alpha Terpineol | 5% | Neryl Acetate | 0.25% |
| Neryl Acetate | 2% | Gamma Terpinene | 8% | Linalool | 0.5% |
| Nerolidol | 2% | Beta Pinene | 10% | Myrcene | 1.4% |
| Citral | 10% | Citral | 10% | Limonene D | 97.5% |
| Limonene D | 80% | Limonene D | 60% | | |

Table 3 shows different ingredient combinations for lemon flavor compound, lime flavor compound, and orange flavor compound. However, this is not limiting and ingredient combinations for other types of citrus fruit may also be used, such as yuzu and grapefruit. As detailed above in step 204 for preparing and combining ingredients for the oil phase 104, the ingredients and their amounts for three specific citrus fruits are shown in Table 3. Regardless of whether lemon flavor compound, lime flavor compound, or orange flavor compound is selected, the flavor compound is added to the oil phase 104 at 50 to 100 parts per million. Additionally, the citrus fruit type may be for a single citrus fruit or a mix of more than one citrus fruit type. For example, the flavor compound may be a mix of half lemon and half lime as long as the total flavor compound added to the oil phase 104 is within the above stated range of 50 to 100 parts per million.

Advantageously, the method 200 for creating a shelf stable citrus flavoring composition and the flavoring composition thereof described above provides the complexity, texture, odor, and flavor of citrus juices. The citrus flavoring composition is low cost, limits oxidization, is not dependent on agricultural conditions, and produces only a fraction of kitchen waste compared to freshly squeezed juice. The flavoring composition is low cost in the materials and ingredients used and saves the time and labor cost compared to freshly squeeze citrus fruit. The flavoring composition cost can be further lowered by not including zest from fresh citrus fruit, thus not utilizing fresh fruit and skipping the steps 208, 212 of preparing, adding, and filtering the zest. Furthermore, the flavoring composition has flexibility in mixing and matching citrus fruit types in the aqueous phase 102 for taste by the tongue and in the oil phase 104 for flavor and smell, which may be usefully added by a user to any type of food or drink including to candy, chocolate, beverages, or any other type of consumable item. Moreover, functional oils with functional utilities added in the oil phase 104 may add properties and benefits such as, but not limited to, antioxidant, antimicrobial, antiviral, anti-inflammatory, antiseptic, antifungal, anticancer, hormone balancing, immune enhancing, detoxification promoting, stimulation, sedation, calming, etc.

While preferred and non-limiting embodiments of the present invention have been described, various other adaptations and modifications may be envisioned by those of ordinary skill in the art without departing from the scope and spirit of the invention. Many other advantages and benefits may be provided by the one or more systems and components described herein.

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted. The term “coupled to” as used herein may refer to a direct or indirect connection.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

1. A flavoring composition comprising:
an aqueous phase; and
an oil phase, comprising
an essential oil and/or functional oil at 100 to 200 parts per million (ppm);
a flavor compound mixture at 50 to 100 ppm; and
a weighting agent proportionate to the total amount of the essential oil and/or functional oil and the flavor compound mixture,
wherein the weighting agent ranges 150 to 300 ppm, and
wherein the flavoring composition is a citrus flavoring composition and a homogenous nano emulsified mixture.

2. (canceled)

3. (canceled)

4. The flavoring composition of claim 1, wherein the aqueous phase resembles high acidity citrus fruit characteristics, wherein a final pH of the aqueous phase is two or less and wherein high acidity citrus fruits comprise any citrus fruit that has more than 3% acid by weight.

5. The flavoring composition of claim 4, wherein the aqueous phase for high acidity citrus fruits comprises (measured in percent by weight):
0.50 to 2.00% sucrose;
1.0 to 8.0% citric acid;
0.0 to 5.0% malic acid;
0 to 0.10% succinic acid;
0% dextrose;
0 to 0.10% vitamin E,
0.05 to 0.50% ascorbic acid;
0.5 to 3.0% fructose;
0.05 to 0.50% sodium;
0.05-0.50% emulsifier;
0.05 to 0.50% texturizer, and
a remaining percentage of water.

6. The flavoring composition of claim 4, wherein an aqueous phase imparting lemon characteristics comprises (measured in percent by weight): 0.5% sucrose; 6.0% citric acid; 0% malic acid; 0% succinic acid; 0% dextrose; 0.05% vitamin E, 0.10% ascorbic acid; 1.30% fructose; 0.10% sodium; 0.10% emulsifier; 0.10% texturizer, and a remaining percentage of water.

7. The flavoring composition of claim 4, wherein an aqueous phase imparting lime characteristics comprises (measured in percent by weight): 0.5% sucrose; 4.0% citric acid; 2.0% malic acid; 0.02% succinic acid; 0% dextrose; 0.05% vitamin E, 0.10% ascorbic acid; 1.0% fructose; 0.10% sodium; 0.10% emulsifier; 0.10% texturizer, and a remaining percentage of water.

8. (canceled)

9. The flavoring composition of claim 4, wherein an emulsifier in the aqueous phase comprises gum acacia.

10. The flavoring composition of claim 4, wherein a texturizer in the aqueous phase comprises pectin.

11. The flavoring composition of claim 1, wherein the weighting agent comprises sucrose acetate isobutyrate or ester gum.

12. The flavoring composition of claim 1, wherein the oil phase is added at 150 to 500 parts per million when combined with the aqueous phase.

13. The flavoring composition of claim 1, wherein the aqueous phase, the essential oil, and the flavor compound mixture each impart characteristics of a same citrus fruit type or a combination of two or more citrus fruit types;
wherein the aqueous phase imparts characteristics of a single citrus fruit type or a combination of two or more citrus fruit types; and
wherein the flavor compound mixture imparts characteristics of a single citrus fruit type or a combination of two or more citrus fruit types.

14. A method for preparation of a flavoring composition comprising:
preparing and combining ingredients for an aqueous phase;
preparing and combining ingredients for an oil phase;
wherein the oil phase comprises essential oil and/or functional oil at 100 to 200 parts per million (ppm); a flavor compound mixture at 50 to 100 ppm; and a weighting agent proportionate to the total amount of the essential oil and/or functional oil and the flavor compound mixture;
combining the aqueous phase and the oil phase;
processing the mixture using a rotor stator and ultrasonic homogenizer until a stable nano emulsion is formed;
checking the stable nano emulsion for droplet size and adjusting pH; and
packaging the stable nano emulsion, wherein all steps in the method are carried out in an oxygen-free environment.

15. The method of claim 14, further comprising preparing and adding citrus zest from a citrus fruit before processing the mixture in the rotor stator and ultrasonic homogenizer, and filtering the nano emulsion with a 20-micron filter within 30 minutes or less of the citrus zest addition.

16. The method of claim 14, wherein the aqueous phase comprises 1.0-10.0% of total acids by weight, 0.05-1.5% of total emulsifiers by weight, 0.05-1.5% of total texturizers by weight, and 0.5%-30% of total sugars by weight.

17. The method of claim 16, wherein the aqueous phase for high acidity citrus fruits comprises (measured in percent by weight):
0.50 to 2.00% sucrose;
1.0 to 8.0% citric acid;
0.0 to 5.0% malic acid;
0 to 0.10% succinic acid;
0% dextrose;
0 to 0.10% vitamin E,
0.05 to 0.50% ascorbic acid;
0.5 to 3.0% fructose;
0.05 to 0.50% sodium;
0.05-0.50% emulsifier;
0.05 to 0.50% texturizer, and
a remaining percentage of water,
wherein high acidity means a pH of 2 or less for the aqueous phase; and
wherein the aqueous phase for medium acidity fruits comprises (measured in percent by weight):
1.0 to 8.0% sucrose;
1.0 to 3.0% citric acid;
0.0 to 3.0% malic acid;
0.0% succinic acid;
1.0 to 5.0% dextrose;
0 to 0.10% vitamin E,
0.05 to 0.50% ascorbic acid;
1.0 to 8.0% fructose;
0.05 to 0.50% sodium;
0.05-0.50% emulsifier;
0.05 to 0.50% texturizer; and
a remaining percentage of water,
wherein medium acidity means a pH greater than 2 and 3 or less for the aqueous phase.

18. The method of claim 17, wherein a final pH of the aqueous phase is two or less for high acidity citrus fruits and three or less for medium acidity citrus fruits, wherein high acidity citrus fruits comprise any citrus fruit that has more than 3% acid by weight for the aqueous phase, and wherein medium acidity citrus fruits comprise any citrus fruit that has 3% or less acid by weight for the aqueous phase.

19. The method of claim 18, wherein the aqueous phase imparting lemon characteristics comprises (measured in percent by weight): 0.5% sucrose; 6.0% citric acid; 0% malic acid; 0% succinic acid; 0% dextrose; 0.05% vitamin E, 0.10% ascorbic acid; 1.30% fructose; 0.10% sodium; 0.10% emulsifier; 0.10% texturizer, and a remaining percentage of water.

20. The method of claim 18, wherein the aqueous phase imparting lime characteristics comprises (measured in percent by weight): 0.5% sucrose; 4.0% citric acid; 2.0% malic acid; 0.02% succinic acid; 0% dextrose; 0.05% vitamin E, 0.10% ascorbic acid; 1.0% fructose; 0.10% sodium; 0.10% emulsifier; 0.10% texturizer, and a remaining percentage of water.

21. The method of claim 18, wherein the aqueous phase imparting orange characteristics comprises (measured in percent by weight): 4.0% sucrose; 1.0% citric acid; 0.20% malic acid; 0% succinic acid; 2.0% dextrose; 0.05% vitamin E, 0.10% ascorbic acid; 2.0% fructose; 0.20% sodium; 0.15% emulsifier; 0.20% texturizer, and a remaining percentage of water.

22. The method of claim 16, wherein an emulsifier in the aqueous phase comprises gum acacia.

23. The method of claim 16, wherein a texturizer in the aqueous phase comprises pectin.

24. The method of claim 14, wherein the weighting agent comprises sucrose acetate isobutyrate or ester gum.

25. The method of claim 14, wherein the flavor compound mixture imparting lemon flavor comprises (measured in percent by volume): 1% alpha pinene; 1% linalool; 2% sabinene; 2% myrcene; 2% neryl acetate; 2% nerolidol; 10% citral; and 80% limonene D.

26. The method of claim 14, wherein the flavor compound mixture imparting lime flavor comprises (measured in percent by volume): 2% linalool; 2% sabinene; 3% myrcene; 5% alpha terpineol; 8% gamma terpinene; 10% beta pinene; 10% citral; and 60% limonene D.

27. The method of claim 14, wherein the flavor compound mixture imparting orange flavor comprises (measured in percent by volume): 0.05% beta pinene; 0.1% sabinene; 0.2% citral; 0.25% neryl acetate; 0.5% linalool; 1.4% myrcene; and 97.5% limonene D.

28. The method of claim 14, wherein the oil phase is added at 150 to 500 parts per million when combined with the aqueous phase.

29. The method of claim 14, wherein the aqueous phase, the essential oil and/or functional oil, and the flavor compound mixture may all impart characteristics of a same citrus fruit type or a combination of two or more citrus fruit types;
wherein the aqueous phase may impart characteristics of a single citrus fruit type or a combination of two or more citrus fruit types; and
wherein the flavor compound mixture may impart characteristics of a single citrus fruit type or a combination of two or more citrus fruit types.
